(19) United States
(12) Patent Application Publication
(10) Pub. No.: US 2015/0006409 A1
(43) Pub. Date: Jan. 1, 2015

(54) EQUIPPING ITEMS WITH DIGITAL PROFILES AND SERVICES

(71) Applicant: qipp ag, Basel (CH)

(72) Inventor: Stefan Zanetti, Binningen (CH)

(73) Assignee: qipp ag, Basel (CH)

(21) Appl. No.: 14/262,967

(22) Filed: Apr. 28, 2014

Related U.S. Application Data
(60) Provisional application No. 61/840,714, filed on Jun. 28, 2013.

(51) Int. Cl. G06Q 30/00

(52) U.S. Cl. CPC G06Q 30/016
USPC 705/304

(57) ABSTRACT

Techniques for allowing a user to use one or more services associated with one or more items in the user's collection of items. The techniques include accessing a digital profile of a first item; identifying, using at least one processor, at least a first service to associate with the first item based on information about the first item; and providing a user with access to at least the first service.

### CROSS-REFERENCE TO RELATED APPLICATIONS

This application claims the benefit under 35 U.S.C. §119(e) of U.S. Provisional Application Ser. No. 61/840,714, entitled “EQUIPPING ITEMS WITH DIGITAL PROFILES AND SERVICES” filed Jun. 28, 2013, which is herein incorporated by reference in its entirety.

### BACKGROUND

A consumer may perform various post-purchase activities related to a purchased product. Examples of such post-purchase activities include returning or reselling the purchased product, looking up information about the purchased product (warranty, user's manual, online frequently asked questions, etc.), and purchasing additional or replacement parts.

### SUMMARY

Some embodiments provide for a method comprising: accessing a digital profile of a first item; identifying, using at least one processor, at least a first service to associate with the first item based on information about the first item; and providing a user with access to at least the first service.

Other embodiments provide for a system comprising at least one processor programmed to perform: accessing a digital profile of a first item; identifying, using at least one processor, at least a first service to associate with the first item based on information about the first item; and providing a user with access to at least the first service.

Still other embodiments provide for at least one non-transitory computer readable storage medium storing processor-executable instructions that, when executed by at least one processor, cause the at least one processor to perform: accessing a digital profile of a first item; identifying, using at least one processor, at least a first service to associate with the first item based on information about the first item; and providing a user with access to at least the first service.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same or a similar reference number in all the figures in which they appear.

FIG. 1 shows an illustrative environment in which some embodiments may operate.

FIG. 2 is a flow chart of an illustrative process for adding one or more items to a user's collection of items, in accordance with some embodiments.

FIG. 3 is a flow chart of an illustrative process for providing a user with ability to use one or more services associated with one or more items in the user's collection, in accordance with some embodiments.

FIG. 4 is a block diagram of an illustrative computer system that may be used in implementing some embodiments.

### DETAILED DESCRIPTION

As described above, consumers perform various post-purchase activities for products they have obtained (e.g., purchased, received as gifts, etc.). In order to perform a post-purchase activity for a particular product (e.g., return a purchased product, purchase a replacement part, extend a warranty covering the product, etc.), a consumer needs to access information that would allow him/her to perform such as the activity (e.g., information specifying where to send the product being returned, how to purchase a replacement part, what the warranty is for the product, etc.). The Applicants have recognized that consumers have multiple purchased products, but no single means of accessing all the information associated with each of these products. Accordingly, some embodiments provide for a system configured to present a user with a unified interface for accessing information for one or more products the user owns and/or any other suitable items the user may desire to access information about.

To this end, some embodiments provide for a system configured to maintain a collection of items for each of its users. Each item (thing) in a user's collection may have a digital profile comprising information associated with the item. Each item in the user's collection may also be associated with one or more services (termed qippets) that a user may use in connection with the item. Different items in the user's collection may be associated with different services. A service may be implemented as software facilitating the performance of one or more tasks in connection with the item that the user desires to be performed. The system may implement each service as software. The software code for any service(s) may be executed on any suitable processor or collection of processors, whether provided in a single computer or distributed among multiple computers. Various examples of items and services are provided below.

A user may use the system to perform any of numerous types of actions for one or more items. For example, the user may add an item to his/her collection of items by creating a digital profile for the item or adopting an existing digital profile for the item. As another example, the user may access and/or edit information in the digital profile of an item in the user's collection. As yet another example, the user may identify one or more services to associate with one or more items in the user's collection. As yet another example, the user may use one or more services associated with one or more items in the user's collection.

In some embodiments, the system may be implemented as a web-based software whereby users access the software via the Internet (e.g., using a web-browser and/or a dedicated software application) to perform actions for one or more items. As one non-limiting example, a user may access the software by logging in via an appropriate website and be presented with a list of items in his/her collection. The user may then select an item in his collection and be presented with the digital profile of the selected item, the digital profile identifying one or more services associated with the selected item. The user may then select and use one of the services associated with the selected item.

An item in a user's collection may be an item the user has obtained (e.g., by purchasing the item, finding the item, creating the item, receiving the item as a gift, etc.), an item that the user wishes to obtain (e.g., wishes to buy, wishes to create, wishes to receive as a gift, etc.), or any other item or thing the user wishes to have in his/her collection.

A user's collection may have any suitable number of items of any suitable type. Examples of items include, but are not limited to print and electronic media (e.g., books, CDs, DVDs, etc.), electronics (e.g., televisions, video cameras, photo cameras, cell phones, etc.), appliances, computers (e.g., desktops, laptops, personal digital assistants, tablet computers, etc.), kitchen supplies, furniture, bedding supplies, dining supplies, garden and landscaping supplies, tools, building materials, arts and crafts supplies, pet supplies, food, health and personal care products, beauty products, toys, games, baby supplies, clothing, shoes, bags, luggage, jewelry, decorations, sporting equipment, outdoors equipment, school supplies, office supplies, medical supplies, lamps and light fixtures, transportation items (e.g., bicycles, cars, motorbikes, etc.), items created by the user (e.g., art created by the user, devices built by the user, media created by the user, etc.) and/or any of other numerous types of items, as aspects of the disclosure provided herein are not limited in this respect.

As previously described, an item in the user's collection may be associated with a digital profile comprising information about the item. A digital profile may comprise any suitable information about the item including, but not limited to, a name of the item, a textual description of the item, one or more images of the item, the user's personal notes about the item, information describing how the user obtained the item, purchase price of the item, etc. Additionally, a digital profile of an item in the user's collection may identify one or more services associated with the item.

An item may be associated with any suitable number of services (qippets) of any suitable type. Each service associated with an item may provide for one or more capabilities or functions that may be performed in connection with the item. As previously described, each service may be implemented as software.

Illustrative examples of various services are described below. Though, it should be appreciated that these examples of services are not an exhaustive listing of services that may be associated with an item, as an item may, additionally or alternatively, be associated with any other suitable services. Additional examples of services are provided in Appendices A and B, each of which is hereby incorporated by reference in its entirety.

An item may be associated with any of numerous types of services for providing a user with information about the item. For example, an item may be associated with a service configured to provide access to a manual for the item. Such a service may be termed a “manual” service. For instance, if a manual service is associated with an appliance item (e.g., dishwasher) in the user's collection, the user may use the service to access a manual for the appliance. As another example, an item may be associated with one or multiple services configured to provide access to any of numerous types of documents associated with an item such as an instruction manual, specifications, warranty, frequently asked questions, etc.

An item may be associated with a service configured to allow a user to add images to the digital profile of the item. Such a service may be termed a “pictures” service. The pictures service may allow the user to add (e.g., upload) his/her own images (e.g., photographs, drawings, etc.) to the digital profile of the item. The pictures service may also allow the user to or search for images provided by other entities (e.g., the manufacturer of the item, a distributor of the item, a retailer selling the item, etc.).

An item may be associated with a service configured to help a third party contact a user if the user were to lose the item. Such a service may be termed a “lost and found” service. The lost and found service may be used to associate the item with a unique physical identifier (e.g., a near field communications tag (NFC), a quick response (QR) code, and/or any other suitable identifier). The physical identifier may be affixed to the item. In some embodiments, the lost and found service may provide the user with a means for physically tagging the item with an identifier (e.g., the user may print a sticker with the identifier, order a sticker/tag with the identifier, etc.). In other embodiments, the item may already have a physical identifier affixed to it and that identifier may be provided to the lost and found service so that the lost and found service associates the identifier with the item. If the user were to lose the item and the item were found by a third party (e.g., another person), the third party could provide the identifier affixed to the item to the lost and found service (e.g., via a website) and the lost and found service would send a notification to the user, allow the third party to contact the user, and/or perform any other suitable action to allow the user to recover the lost item. The lost and found service may allow the finder of a lost item to be compensated for reporting that they found the item and/or facilitating the return of the lost item to the user. Such compensation may motivate the finder of a lost item to perform these actions.

An item may be associated with a service configured to allow a user to publish content related to the item. Such a service may be termed a “publishing” service. The publishing service may allow the user to publish any suitable content (e.g., pictures of the item, comments about the item, a description of the item, any portion or the entire digital profile of the item, etc.). The service may allow the user to publish content related to the item using any suitable publishing channel. For example, the service may allow the user to publish content related to the item via a blog, a social networking service (e.g., Facebook®), a website, and/or any other suitable publishing channel. The service may allow the user to publish content related to the item and make the published content accessible only to users in a group of users (e.g., a “circle” or group of users imported from a social network, a group of users identified by the user, and/or any other suitable group of users having a right to see information related to the item).

An item may be associated with a service configured to provide reminders and/or any other suitable notifications to a user having the item in his/her collection. Such a service may be termed a “reminder” service. The reminder service may allow the user to specify what reminders and/or notifications to provide to the user in connection with the item and under what conditions such reminders and/or notifications are to be provided to the user. For example, the reminder service may be configured to provide one or more notifications to a user about when a warranty (e.g., a manufacturer's warranty) for the item expires. As another example, the reminder service may be configured to provide one or more notifications to a user about when maintenance is to be performed on the item.

An item may be associated with a service configured to allow a user having the item in his/her collection to obtain (e.g., purchase) an insurance policy for the item. Such a service may be termed an “insurance” service.

An item may be associated with a service configured to allow a user to organize items in his/her collection into groups. Such a service may be called a “collections” service. As an illustrative non-limiting example, the user may have multiple bottles of wine in his collection of items and may wish to organize the bottles into groups (e.g., by region, by varietal, by tasting notes, etc.).

An item may be associated with a service configured to allow the user to lend the item to one or more other users (e.g., if the user has the item in his/her possession) and/or borrow the item from one or more other users (e.g., if someone else has the item in their possession). Such a service may be termed an “exchange” service. The service may allow a user to form an “exchange circle”—a group of users that lend and borrow one or more items from one another. The service may allow the user to form a group of lendable/borrowable items in his/her collection. The service may allow the user to publish a request to borrow a particular item or items. The service may allow the user to view requests to borrow a particular item or items published by one or more other users. The service may allow the user to search for an item to borrow in a particular geographic region (e.g., neighborhood, town, city, state, etc.).

An item may be associated with a service configured to provide information from a manufacturer of the item to the user. Such a service may be termed an “update” service. The update service may provide information to the user about any updates for the item (e.g., a new part to replace an older part, new software upgrade, etc.), new models of the item (e.g., a new model of a dishwasher is available), recalls for the item (e.g., a stroller has been recalled due to safety concerns), and/or any other suitable information from the manufacturer of the item. Though, it should be recognized that the update service is not limited to providing information from a manufacturer of the item and may provide information from any suitable entity associated with the item (e.g., distributor of the item, retailer selling the item, etc.)

An item may be associated with a service configured to provide suggestions of one or more other items to accessorize and/or otherwise complement the item. Such a service may be termed an “accessory” service. The accessory service may provide accessory suggestions for an item based on suggestions and/or recommendations provided by the manufacturer of the item, a distributor of the item, a retailer selling the item, any/or other suitable party. For example, a bicycle item in a user's collection may be associated with the accessory service and the service may recommend one or more bicycle accessories (e.g., helmet, tandem bar, pump, etc.) to the user.

An item may be associated with a service configured to provide the user with a value of the item. Such a service may be termed an “actual value” service. The actual value service may obtain the value of the item to provide to the user in any of numerous ways. In some embodiments, the actual value service may obtain values of the item (or similar items) from one or more sales platforms (e.g., online retailers, databases of secondhand sales, etc.) and calculate a value of the item from the obtained values (e.g., by averaging).

An item may be associated with a service configured to allow the user to obtain additional and/or replacement parts for the item. Such a service may be termed a “replacement” service. For example, if a user needs to replace a part in an appliance, the user may use the replacement service to order the replacement part.

An item may be associated with a service configured to provide a user with one or more incentives to perform one or more actions in connection with the item. Such a service may be termed an “incentives” service. For example, the service may provide the user with a financial incentive (e.g., a voucher, a discount, a rebate, payment, etc.) to purchase the item, purchase a replacement part for the item, purchase another item complementary to the item, lend the item, borrow the item, write a review about the item, and/or perform any other suitable action in connection with the item.

Some services may be associated with any suitable type of item. For example, the publishing service described above may be associated with any suitable type of item (e.g., a wine bottle, a bicycle, an oil painting, etc.). However, some services may be associated with items of a particular type. For example, a wine bottle item may be associated with a service configured to provide the user with information about wine (e.g., tasting notes, matching recipes, information about the producer of the wine, etc.). As another example, a bicycle item may be associated with a service configured to provide a user with information about where a user may ride the bicycle (e.g., maps of bicycle trails, bicycle trails, etc.). Such type-specific services may be created by the manufacturer of the item (e.g., a wine producer, a bicycle manufacturer, etc.) and/or any other suitable entity (e.g., a wine enthusiast, a sommelier, a bicycle storeowner, etc.).

Accordingly, in some embodiments, different items in a user's collection may be associated with different services. For example, a user may have a first item (e.g., a bottle of wine) and a second item (e.g., a bicycle) in his/her collection of items. The first item may be associated with a service not associated with the second item (e.g., a service suggesting recipes to match to the bottle of wine). The second service may be associated with a service not associated with the first item (e.g., a service providing a user with information about where a user may ride a bicycle). Additionally or alternatively, the first and second items may be associated with the same service. For example, the first and second items may each be associated with a publishing service.

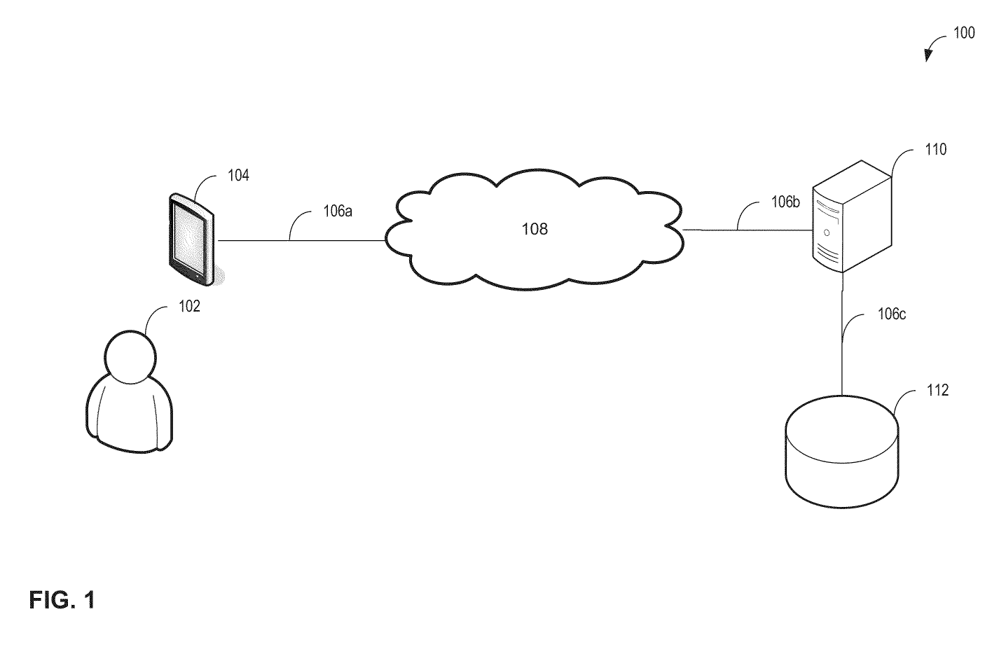

A service may be associated to an item in the user's collection in any suitable way. In some embodiments, the system (e.g., the system described below with reference to FIG. 1) may automatically identify one or more services to associate with the item, without input from the user. The system may identify service(s) to associate with the item based on any suitable information about the item such as the type or product type of the item (e.g., if the item is a wine bottle, one or more services for wine bottles may be identified for associating with the item). In other embodiments, the system may identify one or more services to associate with a user's item based on input from the user. The system may suggest one or more services for an item in the user's collection to the user and the user may select one or more of the suggested services. The system may associate the selected service(s) with the item.

It should be appreciated that the embodiments described herein may be implemented in any of numerous ways. Examples of specific implementations are provided below for illustrative purposes only. It should be appreciated that these embodiments and the features/capabilities provided may be used individually, all together, or in any combination of two or more, as aspects of the present disclosure are not limited in this respect.

Some embodiments of the present application may operate in the illustrative environment 100 shown in FIG. 1. In the illustrative environment 100, user 102 may use computing device 104 to perform one or more actions for one or more items (e.g., any of the types of item(s) described herein and/or any other suitable types of item(s)). For example, user 102 may use computing device 104 to adopt, create, and/or edit a digital profile for one or more items (e.g., adopt a digital profile of an electric drill, create a digital profile for a user's oil painting, edit information in a digital profile of a user's bicycle, etc.). As another example, user 102 may use computing device 104 to identify one or more services (e.g., any of the services described herein or any other suitable services) to associate with one or more items in the user's collection. As yet another example, user 102 may use computing device 104 to use one or more services associated with one or more items in the user's collection. The above-described examples of actions that a user may perform for one or more items are illustrative and non-limiting, as a user may perform any other suitable action for an item.

Computing device 104 may be any electronic device via which the user may perform one or more actions for an item or items. In some embodiments, computing device 104 may be a portable device such as a mobile smart phone, a personal digital assistant (PDA), a laptop computer, a tablet computer, or any other portable device that the user may use to perform one or more actions for one or more items. Alternatively, computing device 104 may be a fixed electronic device such as a desktop computer, a server, a rack-mounted computer, or any other suitable fixed electronic device that the user may use to perform one or more actions for one or more items.

User 102 may perform one or more actions for one or multiple items using any suitable application program(s) on computing device 104. In some embodiments, user 102 may use an Internet web browser program to perform one or more actions for one or more items (e.g., by accessing a website that allows the user to perform the action(s) for the item(s)). In other embodiments, user 102 may use an application program (e.g., an “app” installed on a mobile device) dedicated to providing users of the computing device with ability to perform actions for one or more items.

Computing device 104 is communicatively coupled to server 110, which is configured to provide user 102 with access to information and/or services associated with one or more items. Server 110 may comprise one or multiple computing devices (e.g., servers). In the illustrated embodiment, server 110 and computing device 104 are communicatively coupled via communication links 106a and 106b and network 108. Network 108 may be any suitable type of network such as a local area network, a wide area network, the Internet, an intranet, or any other suitable network. Though, server 110 may be communicatively coupled to computing device 104 in any suitable way, using any suitable types of connections (e.g., wired, wireless, etc.), as aspects of the disclosure provided herein are not limited in this respect. Computing device 104 and server 110 may communicate through any suitable networking protocol (e.g., TCP/IP) because the manner in which information is transferred between server 110 and computing device 104 is not a limitation of aspects of the present disclosure.

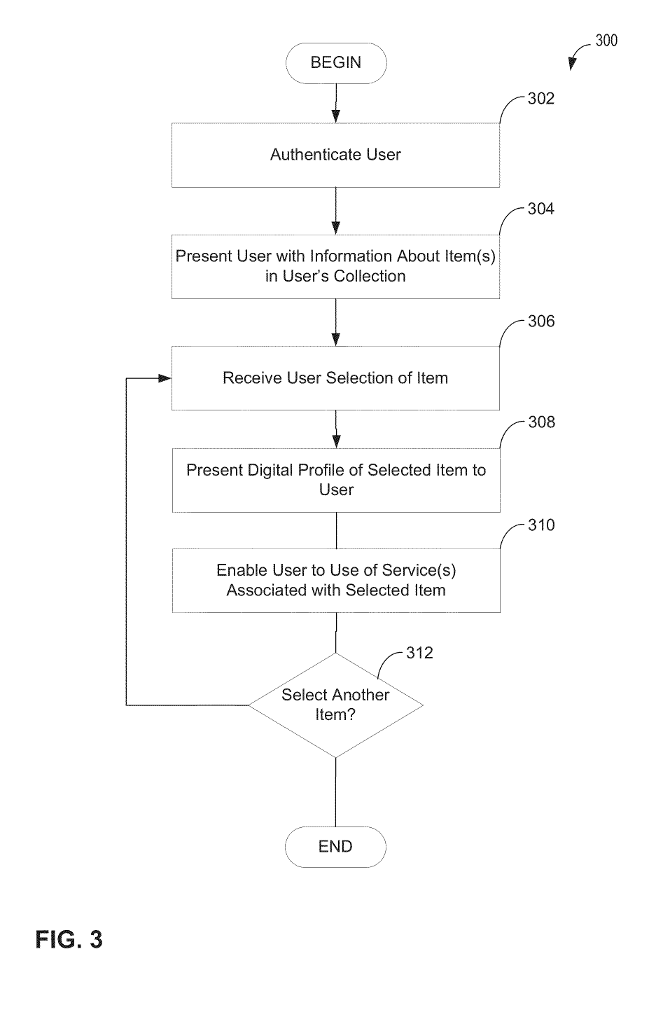

In some embodiments, server 110 may be configured to access information specifying items in a user's collection (e.g., in a collection of items associated with user 102) and digital profiles of the items in the user's collection. Thus, server 110 may be configured to allow user 102 to access and/or edit digital profiles of any item in his/her collection, associate a service or services with any item in his/her collection, and use any service(s) associated with any item in his/her collection. For example, user 102 may login to server 110 (e.g., via a website hosted on server 110) and server 110 may provide computing device 104 with information specifying items in the user's collection (e.g., a webpage listing items in the collection). In turn, computing device 104 may present this information to user 102 (e.g., by displaying the webpage in a web browser application). User 102 may then select an item in the list of items and server 110 may present user 102 with a digital profile corresponding to the selected item and allow user 102 to use any services associated with the selected item. This is described in further detail below with reference to FIG. 3.

In some embodiments, server 110 may be configured to access digital profiles of items not associated with user 102. As such, server 110 may be configured to allow user 102 to access digital profiles of one or more items not in the user's collection and allow user 102 to adopt any such item(s). To this end, server 110 may be configured to associate an item with user 102 (e.g., by placing it into the user's collection), in response to receiving an indication that user 102 wishes to adopt the item.

Server 110 may be configured to implement one or more services associated with one or more items. This may be done in any suitable way. In some embodiments, server 110 may implement a service alone or in combination with one or more other servers. For example, a service for sharing comments about items among users may be implemented using server 110 alone (e.g., users can login to a website hosted on server 110 and post comments about the items on the website) or in combination with one or more other servers implementing a social network (e.g., users can share their comments about items on an existing social network service such as Facebook®, Twitter®, etc.)

Server 110 may be operated by any suitable entity. In some embodiments, server 110 may be operated, directly or indirectly, by a manufacturer, distributor, and/or retailer of one or more products. As an illustrative non-limiting example, server 110 may be operated, directly or indirectly, by an electronics manufacturer and allow users to perform action(s) for items produced by the manufacturer. For example, a user may wish to adopt a digital profile for a product made by the manufacturer that the user is interested in (e.g., a product the user has purchased, wishes to purchase, etc.) and use one or more services associated with the product.

In some embodiments, server 110 may be operated, directly or indirectly, by a business that allows a user to perform actions for items of any suitable type including, but not limited to, items manufactured by one or multiple manufacturers, distributed by one or multiple distributors, sold by one or multiple retailers, and/or any other suitable types of items.

Server 110 may be configured to store and access information in data store 112, which is communicatively coupled to server 110 via communication link 106c. Data store 112 may be configured to store (and allow server 110 to access) any suitable type of information. For example, data store 112 may store information specifying a collection of items associated with each of one or more users. As another example, data store 112 may store digital profiles of any items in a user's collection of items and/or digital profiles of items not in an item collection of any user (e.g., digital profiles of products that one or more users may wish to add to their collection of items). As yet another example, data store 112 may store any information used by any service associated with one or more items in a user's collection of items.

The information stored in data store 112 may be stored in any suitable way and in any suitable format, as aspects of the present disclosure are not limited in this respect. Data store 112 may be implemented in any suitable way, may be part of the server 110 or separate from it, may be implemented using one or multiple devices, and may be connected to the server in any suitable way, as the aspects of the disclosure invention are not limited in this respect.

It should be appreciated that environment 100 is illustrative and non-limiting and that variations of environment 100 are possible. For example, although in the illustrated embodiment only a single user (user 102) is shown, any suitable number of users may access server 110, by using their respective devices, as aspects of the present disclosure are not limited in this respect. As another example, although in the illustrated embodiment user is shown as using a single computing device 104, user 102 may use any suitable number of computing devices of any suitable type to perform one or more actions for one or multiple items, as aspects of the present disclosure are not limited in this respect.

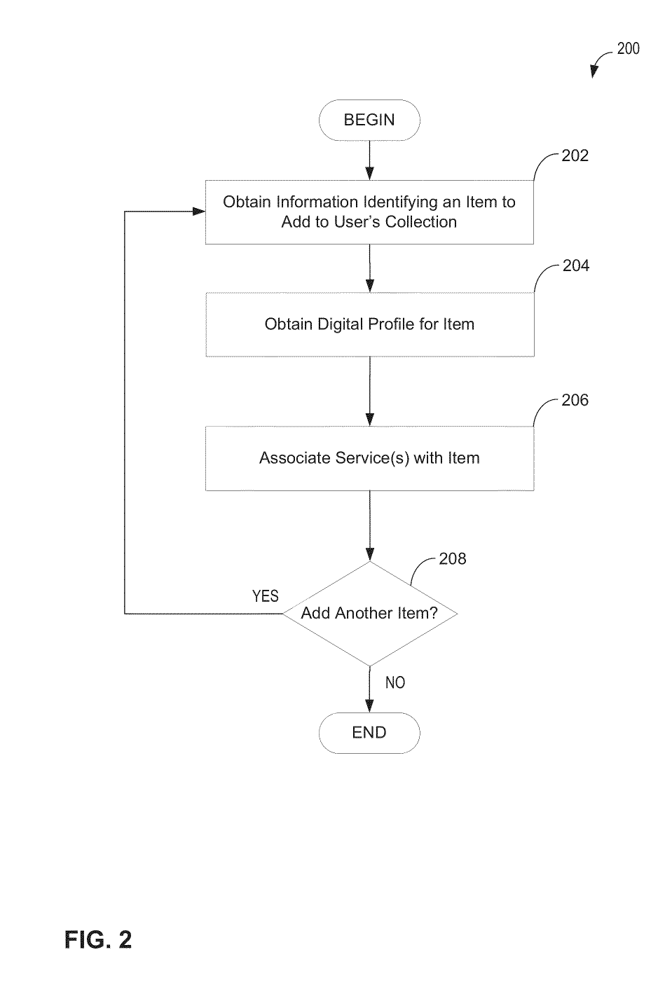

Computing environment 100 may be used to implement any suitable technique or techniques for enabling users to create, edit, and/or maintain collections of items. One such technique is illustrated in FIG. 2, which is a flow chart of illustrative process 200 for adding one or multiple items to a user's collection of items. Acts of process 200 may be performed by one or more components of computing environment 100 including, but not limited to, server 110.

Process 200 begins in act 202, where information identifying an item to add to a user's collection is obtained by the computing device(s) executing process 200 (e.g., server 110). Such information may be obtained in any suitable way and, for example, may be obtained based on user input identifying an item to add to the user's collection. The user's input may identify the item by including the name of an item, a universal product code (UPC) of the item, an international article number (EAN) of the item, a near field communications code (NFC) of the item, quick response (QR) code of the item, a URL for the item, an e-mail address for the item, and/or any other suitable identifier of the item. For example, the user may wish to add a product the user purchased (e.g., a Bosch® drill) to the user's collection of items and may identify the product by inputting a universal product code, scanning an NFC tag, or in any other suitable way. As another example, the user may wish to add an item the user created (e.g., a painting the user painted, a car the user modified, a device the user built, etc.) and may identify the created item by a name. As yet another example, an item may be associated (e.g., labeled) with a unique e-mail address (e.g., 123456@qipp.it) and the user may send an e-mail to that item's e-mail address to initiate the process of adding the item to the user's collection of items. An item may be associated with any suitable number of identifiers of any suitable type, as aspects of the present disclosure are not limited in this respect. For example, an item may be associated with an e-mail address in addition to or instead of one or more other identifiers (e.g., UPC, NFC, QR code, etc.).

Next process 200 proceeds to act 204, where a digital profile is obtained for the item identified at act 202. This may be done in any suitable way. In some embodiments, obtaining a digital profile for the identified item comprises creating a new digital profile for the item based on information about the item provided by the user. Examples of information about the item include a name of the item, a textual description of the item, one or more images of the item, the user's personal notes about the item, information describing how the user obtained the item, purchase price of the item, etc. It should be appreciated that these examples are merely illustrative, as a user may provide any suitable information about the item to include in the item's digital profile. For example, a digital profile for a painting painted by the user may be created based on information about the painting (e.g., a description of the painting, a title of the painting, a picture of the painting, information about materials used to create the painting, etc.) supplied by the user.

In some embodiments, obtaining a digital profile for the identified item comprises adopting an existing digital profile as the digital profile for the item. This may be done in any suitable way. For example, information identifying the item to be added to the user's collection may be used to locate an existing digital profile for the item among the digital profiles accessible to the computing device(s) (e.g., server 110) executing process 200. For example, data store 112 may store multiple digital profiles and server 110 may use the information identifying the item to be added to locate an existing digital profile, stored in data store 112, for the item. Continuing with the above example of a Bosch® drill, the manufacturer of the drill may have created digital profiles for multiple drills, each digital profile associated with an identifier for a particular drill (e.g., NFC, QR code, URL, e-mail address, etc.). After purchasing a drill, a user may input the identifier of the purchased drill, at act 202, and that identifier may be used to locate the digital profile corresponding to the purchased drill. The located digital profile may be adopted as the digital profile for the purchased drill.

As one non-limiting example, an e-mail address associated with an item may be used to adopt an existing digital profile as the digital profile for the item. A user may send an e-mail to the e-mail address associated with the item (e.g., itemid@qipp.it). The received e-mail may be processed (e.g., by a server) to determine which item is identified by the e-mail (e.g., by using a look up table associating items with e-mail addresses). The identified item may then be added to the user's collection of items. The user may receive a reply e-mail from a server, the sender address of the e-mail being an e-mail address assigned to the identified item, indicating that the item has been added to the user's collection of items or prompting the user to confirm whether the item should be added to the user's collection of items. The e-mail may further include a link that, when clicked, would take the user to a webpage having the digital profile of the item. In this way, a user may adopt an item and/or interact with an item via e-mail.

As may be appreciated from the above, a digital profile for an item in a user's collection may be created by the user or by any suitable entity including a manufacturer of the item, a distributor of the item, a retailer selling the item, the entity operating (directly or indirectly) the computing device(s) implementing process 200, and/or any other suitable entity, as aspects of the present disclosure are not limited in this respect.

Next, process 200 proceeds to act 206, where one or more services may be associated with the item. Any suitable number of services of any suitable type (examples of which have been provided) may be associated with the item in any suitable way. In some embodiments, a service may be identified for association with an item based on user input. A user may be presented with a list of proposed services to associate with the item and may select one or more proposed services in the list to associate with the item. The list of proposed services may include services selected based on information about the item. As a result, different services may be proposed for different items in the user's collection. For example, as illustrated in Appendix B, different services may be proposed for items in different product categories (e.g., tools, clothes, transportation, food, etc.). Though, services to associate with an item may be proposed based on any other suitable information in addition to or instead of the product type of the item, as aspects of the present disclosure are not limited in this respect.

In some embodiments, one or more services may be associated with an item, automatically, without requiring a user to identify specific services to associate with the item. Different services may be automatically associated with different items in the user's collection. For example, an item may be automatically associated with one or multiple services based on the product type of the item and/or any other suitable criteria. As another example, an item may be automatically associated with one or multiple services previously identified by the manufacturer of the item, a distributor of the item, a retailer selling the item, the entity operating (directly or indirectly) the computing device(s) implementing process 200, and/or any other suitable entity.

In some embodiments, information specifying the association between an item in a user's collection and one or more services may be stored in the digital profile of the item. When the digital profile for an item in the user's collection is obtained by adopting an existing digital profile, the adopted digital profile may specify one or more services associated with the item.

After one or more services are associated, at act 206, with the item identified at act 202, process 200 proceeds to decision block 208, where it is determined whether the user wishes to add one or more other items to his/her collection. This determination may be made in any suitable way. For example, it may be determined that a user wishes to add one or more items to his/her collection when the user provides input providing an indication that he/she wishes to add one or more other items to his/her collection. When it is determined that the user wishes to add more items to his/her collection, process 200 returns to act 202 and acts 202-206 are repeated. On the other hand, when it is determined that the user does not wish to add any more items to his/her collection, process 200 completes.

It should be appreciated that process 200 is merely illustrative and that there are many possible variations. For example, in the illustrated embodiment, a user may add one item at a time to his/her collection. However, in other embodiments, a user may add multiple items to the user's collection. For example, the user may adopt a set of two or more items with existing digital profiles (e.g., a set of kitchen appliances from a particular manufacturer). As another example, in some embodiments, a user may attempt to add an item to a collection of items (e.g., by sending an e-mail as described above or any other suitable way), but may not have an account with the service that provides users access to digital profiles of items and associated services). In this case, the user may be guided to register for an account (e.g., a pending user account may be created and the user may be e-mailed to confirm that the user wishes to create a new account) so that the user can begin to add items to a collection and use one or more services associated with the items.

As previously described, a user may perform one or more actions for one or more items in the user's collection using computing environment 100. Such actions include, but are not limited to, viewing the listing of items in the user's collection, viewing and editing digital profiles of the items in the user's collection, and using one or more services associated with one or more items in the user's collection. One technique for allowing the user to perform these actions is illustrated in FIG. 3, which is a flow chart of illustrative process 300 for providing a user with ability to use one or more services associated with one or more items in the user's collection. Acts of process 300 may be performed by one or more components of computing environment 100 including, but not limited to, server 110.

Process 300 may be performed using any suitable user interface. In some embodiments, a user may be presented with output from and may provide input to a website, as part of process 300. In such embodiments, the user may perform one or more actions for one or more items in the user's collection via a web browser application program. In other embodiments, a user may be presented with output from and may provide input to an application program (e.g., a mobile app.) dedicated to allowing the user to manage his collection of items and use one or more services associated with items in the collection.

Process 300 begins at act 302, where a user is authenticated. This may be done in any suitable way. For example, the user may provide, via the user's computing device (e.g., computing device 104), authentication information to the computing device(s) executing process 300 (e.g., server 110). The authentication information may include a user name, a password, answers to one or more identification questions, login information for a social networking service (e.g., Facebook®, Twitter®, etc.), and/or any other suitable authentication information, as known in the art.

After the user is authenticated, process 300 proceeds to act 304, where the information about one or more items in the user's collection may be sent to the user's computing device (e.g., computing device 104) for presentation to the user. For example, a list of items in the collection may be presented to the user. This list of items may be presented using any suitable format, a non-limiting example of which is shown in Appendix A.

Next, process 300 proceeds to acts 306 and 308, where a selection of an item in the user's collection is received from the user and the digital profile of the selected item is presented to user via the user's computing device (e.g., computing device 104). The digital profile may comprise information about one or more services associated with the item. The digital profile may be presented to the user in any suitable format, a non-limiting example of which is shown in Appendix A.

Next, process 300 proceeds to act 310, where a user is presented with any suitable interfaces that enable the user to use the service(s) associated with the selected item. After a user uses one or more services for the selected item, the user may select another item in his/her collection.

Accordingly, process 300 proceeds to decision block 312, where it is determined whether the user has selected another item in his/her collection. When it is determined that the user has selected another item, process 300 returns to act 306. On the other hand, when it is determined that the use did not select another item (e.g., the user logs out, closes a browser window, closes the application, etc.), process 300 completes.

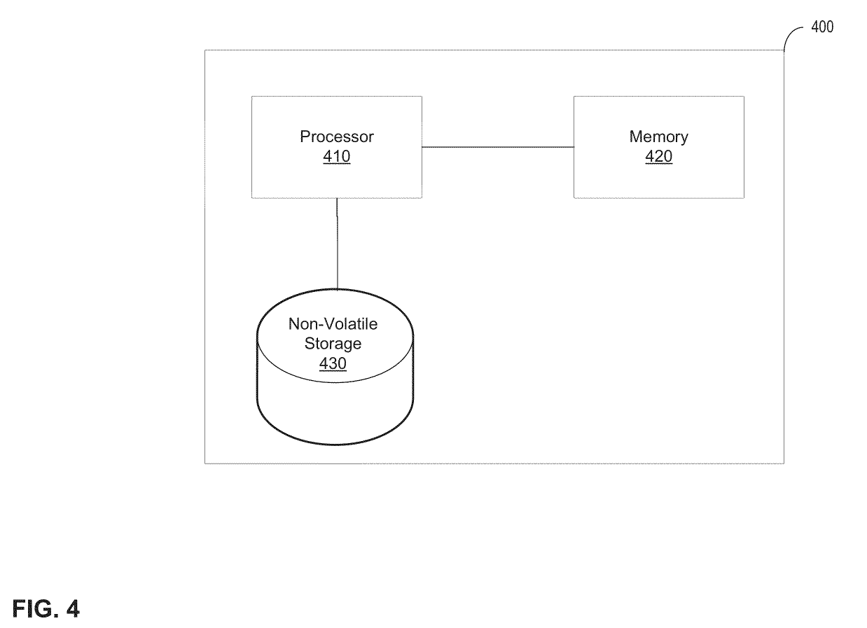

An illustrative implementation of a computer system 400 that may be used in connection with any of the embodiments of the disclosure provided herein is shown in FIG. 4. The computer system 400 may include one or more processors 410 and one or more articles of manufacture that comprise non-transitory computer-readable storage media (e.g., memory 420, one or more non-volatile storage media 430, etc.). The processor 410 may control writing data to and reading data from the memory 420 and the non-volatile storage device 430 in any suitable manner, as the aspects of the disclosure provided herein are not limited in this respect. To perform any of the functionality described herein, the processor 410 may execute one or more processor-executable instructions stored in one or more non-transitory computer-readable storage media (e.g., the memory 420), which may serve as non-transitory computer-readable storage media storing processor-executable instructions for execution by the processor 410.

The various methods or processes outline herein may be coded as software that is executable on one or more processors that employ any one of a variety of operating systems or platforms. Additionally, such software may be written using any of numerous suitable programming languages and/or programming or scripting tools, and also may be compiled as executable machine language code or intermediate code that is executed on a virtual machine or a suitable framework.

The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more processes, of which examples (FIGS. 2 and 3) have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, and/or ordinary meanings of the defined terms.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

Some aspects of the technology described herein may be understood further based on the non-limiting illustrative embodiments described in Appendix A and Appendix B, each of which is hereby incorporated by reference in its entirety. Any limitations of the embodiments described in Appendix A and/or Appendix B are limitations only of the embodiments described in Appendix A and/or Appendix B, and are not limitations of any other embodiments described herein.

What is claimed is:

1. A method, comprising:
accessing or creating a digital profile of a first item;
identifying, using at least one processor, at least a first service to associate with the first item based on information about the first item; and
providing a user with access to at least the first service.

2. The method of claim 1, wherein identifying at least the first service is performed based on a product type of the first item.

3. The method of claim 1, wherein identifying at least the first service comprises:
presenting a user with a set of proposed services selected based on information about the first item, the set of proposed services including the first service; and
receiving a selection of the first service from the user.

4. The method of claim 1, further comprising:
accessing a digital profile of a second item different from the first item; and
identifying a second service, different from the first service, to associate with the second item based on information about the second item.

5. The method of claim 1, further comprising:
creating the digital profile for the first item based at least in part on information identifying the first item provided by the user.

6. The method of claim 1, further comprising:
adopting the digital profile for the first item.

7. The method of claim 1, wherein the first item is in the user's collection of items.

8. A system comprising:
at least one processor configured to perform:
accessing a digital profile of a first item;
identifying, using at least one processor, at least a first service to associate with the first item based on information about the first item; and
providing a user with access to at least the first service.

9. The system of claim 8, wherein identifying at least the first service is performed based on a product type of the first item.

10. The system of claim 8, wherein identifying at least the first service comprises:
presenting a user with a set of proposed services selected based on information about the first item, the set of proposed services including the first service; and
receiving a selection of the first service from the user.

11. The system of claim 8, wherein the at least one processor is further configured to perform:
accessing a digital profile of a second item different from the first item; and
identifying a second service, different from the first service, to associate with the second item based on information about the second item.

12. The system of claim 8, wherein the at least one processor is further configured to perform:
creating the digital profile for the first item based at least in part on information identifying the first item provided by the user.

13. The system of claim 8, wherein the at least one processor is further configured to perform:
adopting the digital profile for the first item.

14. The system of claim 8, wherein the first item is in the user's collection of items.

15. At least one non-transitory computer readable storage medium storing processor executable instructions that, when executed by at least one processor, cause the at least one processor to perform a method comprising:
accessing a digital profile of a first item;
identifying, using at least one processor, at least a first service to associate with the first item based on information about the first item; and
providing a user with access to at least the first service.

16. The at least one non-transitory computer readable storage medium of claim 15, wherein identifying at least the first service is performed based on a product type of the first item.

17. The at least one non-transitory computer readable storage medium of claim 15, wherein identifying at least the first service comprises:
presenting a user with a set of proposed services selected based on information about the first item, the set of proposed services including the first service; and
receiving a selection of the first service from the user.

18. The at least one non-transitory computer readable storage medium of claim 15, wherein the method further comprises:
accessing a digital profile of a second item different from the first item; and
identifying a second service, different from the first service, to associate with the second item based on information about the second item.

19. The at least one non-transitory computer readable storage medium of claim 15, wherein the method further comprises:
creating the digital profile for the first item based at least in part on information identifying the first item provided by the user.

20. The at least one non-transitory computer readable storage medium of claim 15, wherein the method further comprises:
adopting the digital profile for the first item.
